(19) United States
(12) Patent Application Publication
(10) Pub. No.: US 2011/0032990 A1
(43) Pub. Date: Feb. 10, 2011

(54) APPARATUS AND METHOD FOR DEBLOCKING FILTERING IMAGE DATA AND VIDEO DECODING APPARATUS AND METHOD USING THE SAME

(75) Inventors: Woong-Il CHOI, Hwaseong-si (KR); Dae-Sung CHO, Seoul (KR); Jung-Hak NAM, Seoul (KR); Dong-Gyu SIM, Seoul (KR); Hyun-Ho JO, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD., Suwon-si (KR); Kwangwoon University Industry-Academic Collaboration Foundation, Seoul (KR)

(21) Appl. No.: 12/850,094

(22) Filed: Aug. 4, 2010

(30) Foreign Application Priority Data
Aug. 4, 2009 (KR) 10-2009-0071730

(51) Int. Cl. H04N 7/26

(52) U.S. Cl. 375/240.13; 375/240.29; 375/E07.193

(57) ABSTRACT

A deblocking filtering apparatus and method for removing block distortion of a decoded image, and a video decoding apparatus and method using the same. The deblocking filtering method includes extracting parameter information for a plurality of unit blocks in a macro block, from a header of an input current frame, determining whether to perform deblocking filtering, based on the extracted parameter information, and performing deblocking filtering on the macro block according to the determination result.

### CROSS-REFERENCE TO RELATED APPLICATIONS

This application claims priority from Korean Patent Application No. 10-2009-0071730 filed in the Korean Intellectual Property Office on Aug. 4, 2009, the entire disclosure of which is hereby incorporated by reference.

### BACKGROUND

1. Field

The exemplary embodiments generally relate to a video decoding apparatus and method, and more particularly, to a deblocking filtering apparatus and method for removing block distortion of a decoded image, and a video decoding apparatus and method using the same.

2. Description of the Related Art

The well-known H.264/AVC codec is one of the digital video codec standards having a very high data compression rate. H.264/AVC, the standardization of which was completed in 2003 by Joint Video Team (JVT) organized by ITU-T Video Coding Expert Group (VCEG) and International Organization for Standardization/International Electrotechnical Commission (ISO/IEC) Moving Picture Expert Group (MPEG), is the most widely used video compression technology supporting the highest compression rate, among the video compression technologies which have been developed so far.

To ensure a compression rate higher than those of the existing video compression technologies, H.264/AVC uses technologies such as intra predictions of various modes, a plurality of reference frames, motion prediction for blocks of various sizes, Context-Adaptive Variable-Length Coding (CAVLC), Context-Adaptive Binary Arithmetic Coding (CABAC), and in-loop deblocking filtering.

As stated above, H.264/AVC can advantageously improve a compression rate of image data, but uses the technologies having higher complexity than the existing video codecs, like MPEG-2 and MPEG-4. For example, in an H.264/AVC decoder, a 6-tap interpolation filter, a deblocking filter and a CAVLC technique are the parts having higher complexity than the existing video codecs. This high complexity makes it difficult to use the H.264/AVC decoder in mobile terminals such as a mobile phone.

In this specification, the deblocking filter will be considered among the technologies requiring high complexity in H.264/AVC. Generally, in the video codec standards such as H.264/AVC, since image data is compression-coded in units of blocks consisting of a plurality of pixels and then decoded, blocking artifacts may occur in a restored image. The blocking artifacts are attributed to the following two causes.

First, in a block-based encoding method, since blocks of a predetermined size undergo Discrete Cosine Transform (DCT) and quantization, non-overlapping blocks are subject to independent transform and quantization without considering at all the correlation between adjacent blocks or pixels, thus causing a loss in the original image data. Second, a video codec such as H.264/AVC compensates image data by predicting a motion vector on a block basis, and pixels belonging to one block have the same motion vector, which may cause the blocking artifacts.

The deblocking filter plays a role of improving the quality of finally restored images by smoothing a boundary error of blocks, which occurs in the block-based coding.

However, the conventional deblocking filter performs deblocking filtering by repeating a process of calculating Boundary Strength (BS) values as filter coefficients for adjusting filtering strength, for all horizontal boundaries of pixel blocks constituting a macro block, and calculating BS values as filter coefficients for adjusting filtering strength, for all vertical boundaries of the pixel blocks. Each pixel block consists of a plurality of pixels. As a result, a filtering method of the conventional deblocking filter requires a lot of computation, increasing the complexity and filtering time of the filter.

### SUMMARY

An aspect of an exemplary embodiment is to address at least the above-mentioned problems and/or disadvantages and to provide at least the advantages described below. Accordingly, an aspect of the exemplary embodiment is to provide a low-complexity deblocking filtering apparatus and method for image data, and a video decoding apparatus and method using the same.

In accordance with one aspect of an exemplary embodiment, there is provided a deblocking filtering apparatus for removing block distortion of image data, the apparatus including a parameter extractor for extracting parameter information for a plurality of unit blocks in a macro block, from a header of an input current frame; a decider for determining whether to perform deblocking filtering, based on the extracted parameter information; and a filter for performing deblocking filtering on the macro block according to the determination result.

In accordance with another aspect of an exemplary embodiment, there is provided a deblocking filtering method for removing block distortion of image data, the method including extracting parameter information for a plurality of unit blocks in a macro block, from a header of an input current frame; determining whether to perform deblocking filtering, based on the extracted parameter information; and performing deblocking filtering on the macro block according to the determination result.

In accordance with a further another aspect of an exemplary embodiment, there is provided a decoding apparatus for decoding image data, which includes an entropy decoder for restoring a residual image of an input frame, a dequantizer, and an Inverse Discrete Cosine Transform (IDCT) unit, the apparatus including an inter and intra predictor for generating a predicted picture of an input current frame; and a deblocking filter for extracting parameter information indicating execution/non-execution of entropy coding, from a header of the input current frame, and optionally performing deblocking filtering on a restored image, restored using the predicted picture of the input current frame, according to the extracted parameter information.

### BRIEF DESCRIPTION OF THE DRAWINGS

The above and other aspects and features of certain exemplary embodiments will be more apparent from the following description taken in conjunction with the accompanying drawings, in which:

FIG. 1 is a block diagram showing a structure of a video decoding apparatus to which a deblocking filter is applied according to an exemplary embodiment;

FIG. 2 is a block diagram showing a structure of a deblocking filtering apparatus according to an exemplary embodiment;

FIG. 3 is a flowchart showing a deblocking filtering method according to an exemplary embodiment;

FIG. 4 is a flowchart showing a BS value determining and filtering process in a deblocking filtering method according to an exemplary embodiment;

FIGS. 5 and 6 are diagrams showing the conventional BS value determining and filtering process;

FIGS. 7 and 8 are diagrams showing a BS value determining and filtering process according to an exemplary embodiment;

FIG. 9 is a diagram showing BS value determining and filtering coverage for odd boundaries in a macro block according to an exemplary embodiment; and

FIG. 10 is a diagram showing an example in which BS value determining and filtering coverage for odd boundaries described in FIG. 9 are applied to an extended N×N macro block.

Throughout the drawings, the same drawing reference numerals will be understood to refer to the same elements, features and structures.

### DETAILED DESCRIPTION OF EXEMPLARY EMBODIMENTS

Exemplary embodiments will now be described in detail with reference to the accompanying drawings. In the following description, specific details such as detailed configuration and components are merely provided to assist the overall understanding of exemplary embodiments. Therefore, it should be apparent to those skilled in the art that various changes and modifications of the embodiments described herein can be made without departing from the scope and spirit of the invention. In addition, descriptions of well-known functions and constructions are omitted for clarity and conciseness.

First, basic concepts of the exemplary embodiments will be described in brief. The exemplary embodiments provide a method for optionally performing deblocking filtering using a Coded Block Pattern (CBP) parameter indicating the execution/non-execution of entropy coding (or decoding), and simplifying a process of determining BS values for deblocking filtering. In addition, the exemplary embodiments provide a method for omitting or skipping a deblocking filtering operation during decoding of image data if the CBP parameter has a value of “0” indicating that entropy coding (or decoding) is not applied to a macro block or a skip mode is applied thereto.

The skip mode is predefined in the form of flag information for the same macro blocks between frames to improve compression performance in video compression technologies such as MPEG and H.264/AVC. If the skip mode is set for a certain macro block, a coder transmits only flag information indicating the skip mode, instead of transmitting coded data of the macro block, and a decoder restores the macro block by copying a macro block having the same location in a previous frame.

While H.264/AVC will be considered in exemplary embodiments for the sake of convenience, the deblocking filtering apparatus and method according to the exemplary embodiments may be applied to a variety of video technologies requiring deblocking filtering.

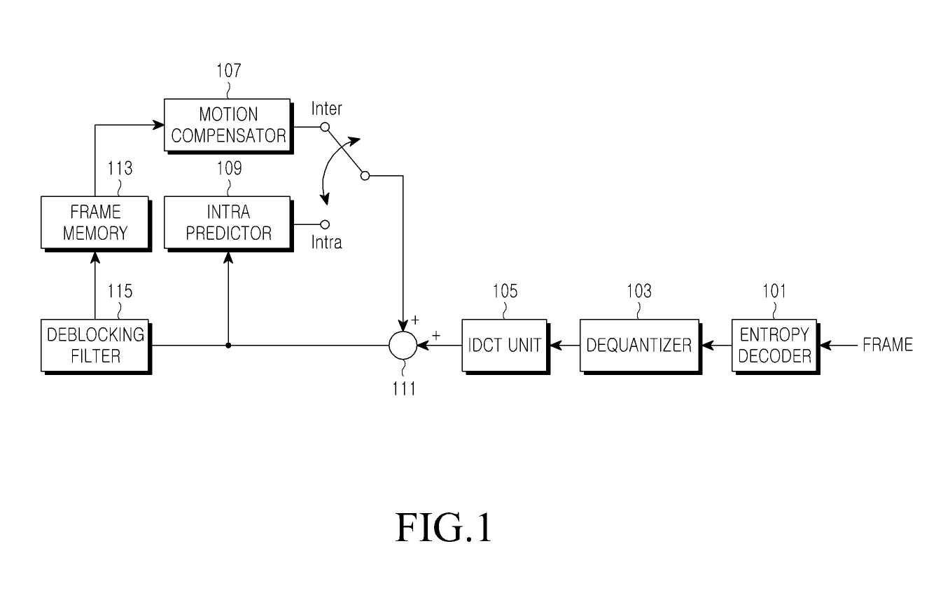

FIG. 1 shows a structure of a video decoding apparatus to which a deblocking filter is applied according to an exemplary embodiment.

Referring to FIG. 1, an entropy decoder 101 entropy-decodes a bitstream of an input current frame and restores a quantized value of a residual image between the current picture and a predicted picture. A dequantizer 103 restores a frequency coefficient of the residual image by dequantizing the quantized value, and an Inverse Discrete Cosine Transform (IDCT) unit 105 restores the residual image by IDCT-transforming the restored frequency coefficient.

A motion compensator 107 generates a predicted picture of the current frame using a motion vector of a reference frame stored in a frame memory 113. An intra predictor 109 generates a predicted picture of the current frame considering spatial redundancy between pixels in a macro block. An adder 111 generates a restored image of the current frame by adding the predicted picture generated by the motion compensator 107 or the intra predictor 109 to the residual image restored by the IDCT unit 105.

A deblocking filter 115 extracts a CBP parameter indicating the execution or non-execution of entropy coding from a header of the current frame, and optionally performs deblocking filtering according to a value of the extracted CBP parameter. Also, the deblocking filter 115 determines a mode type for a macro block from the header of the current frame, and optionally performs deblocking filtering according to the determined mode type.

If deblocking filtering is executed, the deblocking filter 115 performs deblocking filtering using a BS value determined based on the CBP parameter. A filter performing the deblocking filtering may include an in-loop filter that is applied in common to a coding apparatus and a decoding apparatus.

The frame memory 113 stores a restored image of the current frame, block distortion of which is filtered by the deblocking filter 115, and the filtered restored image is used as a reference frame when the predicted picture is generated.

In an exemplary embodiment, the CBP parameter is used as a parameter for determining whether to perform deblocking filtering, but separate information indicating the execution or non-execution of deblocking filtering may be inserted into a header of a frame that is input to a decoding apparatus.

In FIG. 1, all components other than the deblocking filter 115 may be the same as the conventional ones.

Now, the structure and operation of a deblocking filtering apparatus according to an exemplary embodiment will be described in detail.

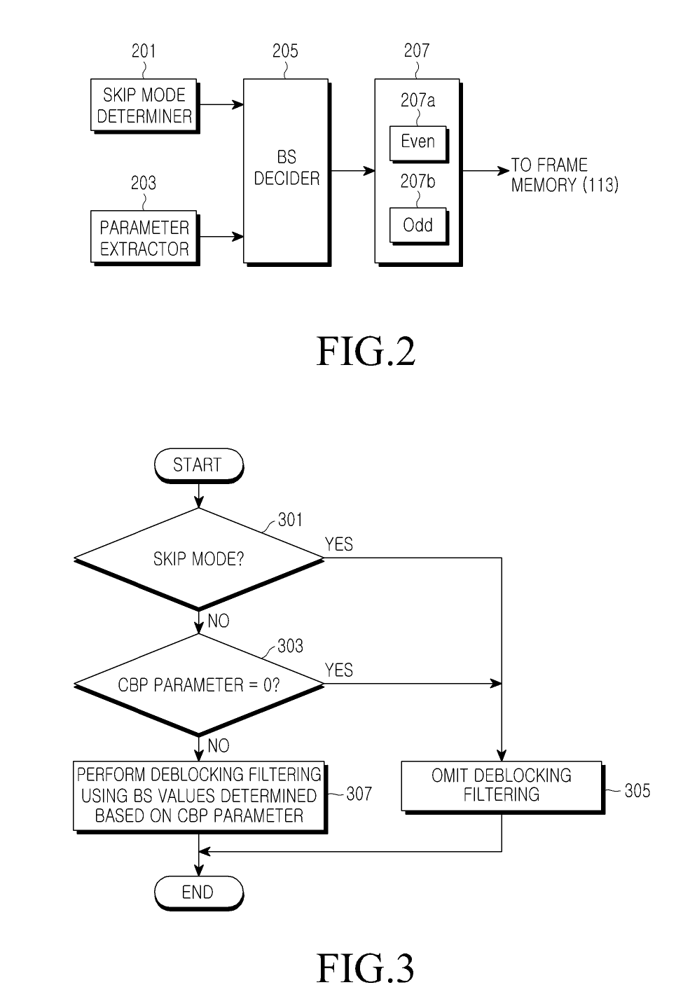

FIG. 2 shows a structure of a deblocking filtering apparatus according to an exemplary embodiment, in which a structure of the deblocking filter 115 is shown.

Referring to FIG. 2, the deblocking filtering apparatus includes at least one of a skip mode determiner 201 for determining whether a mode type of the current macro block is a skip mode to determine whether to perform deblocking filtering, and a parameter extractor 203 for extracting a CBP parameter from a header of an input current frame. The CBP parameter is a parameter indicating whether entropy coding has been executed for each unit block in the original macro block. More specifically, in the H.264/AVC standard, if quantized coefficients are all “0”, coding efficiency may be increased by defining the macro block as an “all-zero” block. That is, if the CBP parameter has a value of “0”, it indicates that entropy coding has not been executed for the relevant unit block. Therefore, if the CBP parameter has a value of “0”, the decoding apparatus may omit or not perform entropy decoding for the unit block. In the exemplary embodiment, the CBP parameter is used as information for determining not only the execution or non-execution of entropy coding but also the execution or non-execution of deblocking filtering.

Although the unit block is defined as an 8×8 block (consisting of 8 pixels in rows and 8 pixels in columns) in, for example, the H.264/AVC standard, the size of the unit block is not limited to the 8×8 block, but can be of a different size.

A BS decider 205, i.e., a decision unit, decides whether to perform deblocking filtering based on the mode type information and/or CBP parameter of a macro block, provided from the skip mode determiner 201 and/or the parameter extractor 203. Upon deciding to perform deblocking filtering, the BS decider 205 performs deblocking filtering on vertical and horizontal boundaries in the macro block using a BS value determined based on the CBP parameter. The BS value is a filter coefficient for adjusting strength of deblocking filtering. Since deblocking filtering based on the BS value is based on conventional technology, a detailed description thereof will not be provided.

In an exemplary embodiment, if the CBP parameter is not “0”, the BS decider 205 decides (or calculates) a BS value for odd boundaries and even boundaries separately in the macro block. For example, the BS decider 205 decides BS values based on the CBP parameter, for vertical and horizontal odd boundaries in the macro block, and decides BS values for even boundaries in the conventional manner. The term “boundary” as used herein refers to adjacent vertical or horizontal boundaries or edges between blocks consisting of a predetermined number of adjacent vertical or horizontal pixels in a macro block.

The BS value determining method of the exemplary embodiment may reduce the required computation compared to the conventional method that should calculate BS values for all horizontal and vertical boundaries in the macro block, and a detailed method for deciding BS values will be described below.

A filter 207 includes an even boundary filter 207a and an odd boundary filter 207b. The even boundary filter 207a performs deblocking filtering on the even boundaries in the macro block using BS values determined by the BS decider 205. The odd boundary filter 207b performs deblocking filtering on the odd boundaries in the macro block using BS values determined by the BS decider 205.

In the example of FIG. 2, different BS values are decided for the even boundaries and the odd boundaries in the macro block, but if deblocking filtering for the even boundaries is omitted, it is also possible to perform deblocking filtering by deciding only BS values for the odd boundaries based on the CBP parameter, thereby further reducing the computation required for deblocking filtering.

While the skip mode determiner 201, the parameter extractor 203 and the BS decider 205 are shown as separate function blocks in the example of FIG. 2, they may be realized as at least one processor or controller.

FIG. 3 shows a deblocking filtering method according to an exemplary embodiment. The method of FIG. 3 will be described with reference to FIG. 2. In an exemplary embodiment, it is assumed that deblocking filtering is basically performed on a macro block basis.

Referring to FIG. 3, the skip mode determiner 201 determines from a header of the current frame whether a mode type of a macro block is a skip mode, in operation 301. If not, the parameter extractor 203 extracts a CBP parameter of each unit block in the macro block from the header of the current frame and determines whether the CBP parameter has a value of “0”, in operation 303. Each of operations 301 and 303 is optional.

In determining whether to perform deblocking filtering using the CBP parameter, if the CBP parameter does not have a value of “0”, the CBP parameter may have a value of “1”, or may have a value indicating a coded block pattern of the unit block. In this case, block distortion requiring deblocking filtering may occur in at least one of the vertical and horizontal boundaries located in the unit block.

If the mode type of the macro block is the skip mode in operation 301 or if the CBP parameter of the unit block has a value of “0” in operation 303, the BS decider 205 controls to omit or to not perform deblocking filtering for the macro block or the unit block in operation 305. If the CBP parameter of the unit block does not have a value of “0” in operation 303, the BS decider 205 decides BS values for the vertical and horizontal boundaries in the macro block according to the CBP parameter in operation 307.

The BS values determined in operation 307 include BS values for the odd boundaries in the macro block, and the BS values determined based on the CBP parameter may include the values determined in advance through experiments, but are not limited to specific values. In addition, the BS values may further include BS values for even boundaries in the macro block, and the BS values for the even boundaries are determined in the conventional way.

Therefore, if the aforementioned deblocking filtering method is used, deblocking filtering is optionally performed according to the use/nonuse of the skip mode and/or the value of the CBP parameter, and during deblocking filtering, the BS values for the odd boundaries are determined as the values predetermined based on the CBP parameter, thereby significantly reducing the computation required in a deblocking filter of a video decoder and thus facilitating realization of a low-complexity deblocking filter.

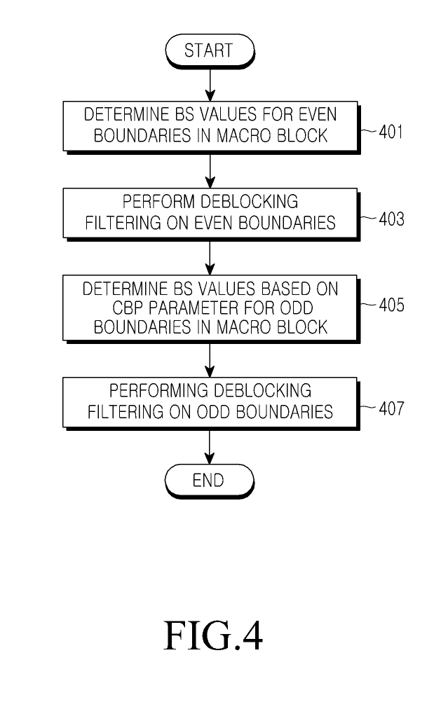

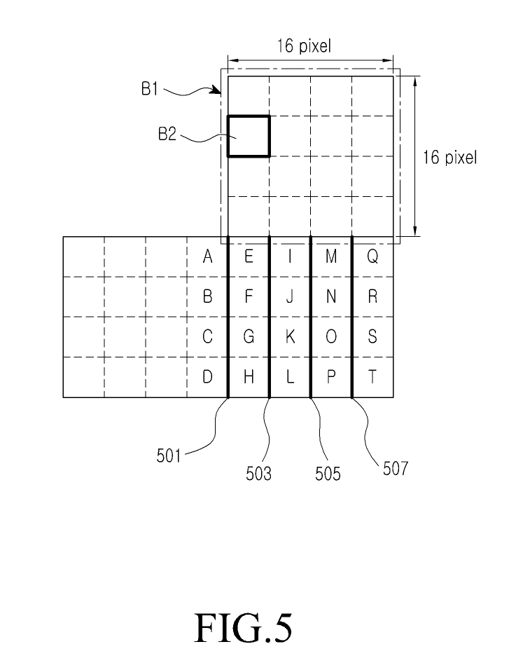

FIG. 4 shows a BS value determining and filtering process in a deblocking filtering method according to an exemplary embodiment, in which details of operation 307 of FIG. 3 are given.

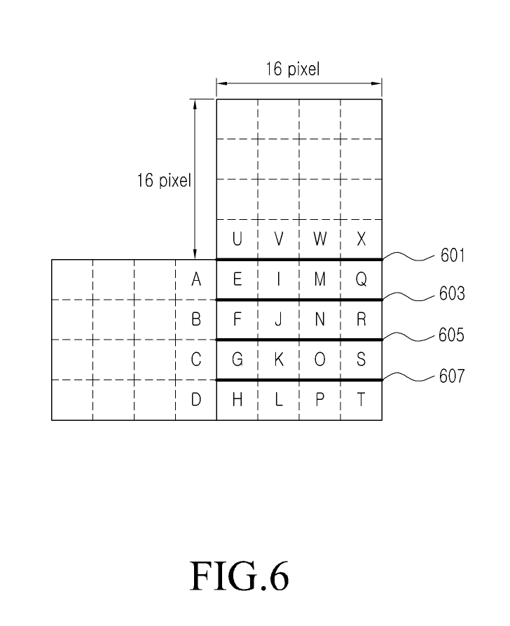

For a better understanding of the exemplary embodiments, the conventional BS value determining and filtering process will first be described with reference to FIGS. 5 and 6. In FIG. 5, B1 represents a 16×16 macro block (consisting of 16 pixels in rows and 16 pixels in columns), and B2 represents an 8×8 unit block. The conventional deblocking filter calculates BS values for vertical boundaries 501, 503, 505 and 507 in the macro block B1 as shown in FIG. 5, and then performs deblocking filtering. Furthermore, as shown in FIG. 6, the conventional deblocking filter calculates BS values for horizontal boundaries 601, 603, 605 and 607, and then performs deblocking filtering. A deblocking filtering process of, for example, the H.264/AVC standard first applies vertical filtering for a given macro block, and then applies horizontal filtering.

During filtering, the conventional deblocking filter calculates BS values for the vertical boundaries 501, 503, 505 and 507 and the horizontal boundaries 601, 603, 605 and 607 as shown in FIGS. 5 and 6, using information such as a coding mode, a motion vector and the number of quantized coefficient values of a given macro block, and then adjusts filtering strength based on the BS values.

More specifically, the conventional deblocking filter calculates BS values for four 4×4 block combinations A-E, B-F, C-G and D-H along the vertical boundary 501, and then performs deblocking filtering on a pixel basis at different filtering strengths according to the calculated BS values. In the same manner, the deblocking filter calculates BS values for four 4×4 block combinations E-I, F-J, G-K and H-L along the vertical boundary 503, BS values for four 4×4 block combinations I-M, J-N, K-O and L-P along the vertical boundary 505, and BS values for four 4×4 block combinations M-Q, N-R, O-S and P-T along the vertical boundary 507, and then performs deblocking filtering on a pixel basis at different filtering strengths according to the calculated BS values.

In addition, the conventional deblocking filter calculates BS values for four 4×4 block combinations U-E, V-I, W-M and X-Q along the horizontal boundary 601, and then performs deblocking filtering on a pixel basis at different filtering strengths according to the calculated BS values. In the same manner, the deblocking filter calculates BS values for four 4×4 block combinations E-F, I-J, M-N and Q-R along the horizontal boundary 603, BS values for four 4×4 block combinations F-G, J-K, N-O and R-S along the horizontal boundary 605, and BS values for four 4×4 block combinations G-H, K-L, O-P and S-T along the horizontal boundary 607, and then performs deblocking filtering on a pixel basis at different filtering strengths according to the calculated BS values.

In the case of the H.264/AVC standard to which the deblocking filtering is applied as described above, if the BS value is 4, filtering is applied to a maximum of 3 pixels along the boundary, and if the BS values are 3, 2 and 1, filtering is applied to a maximum of 2 pixels.

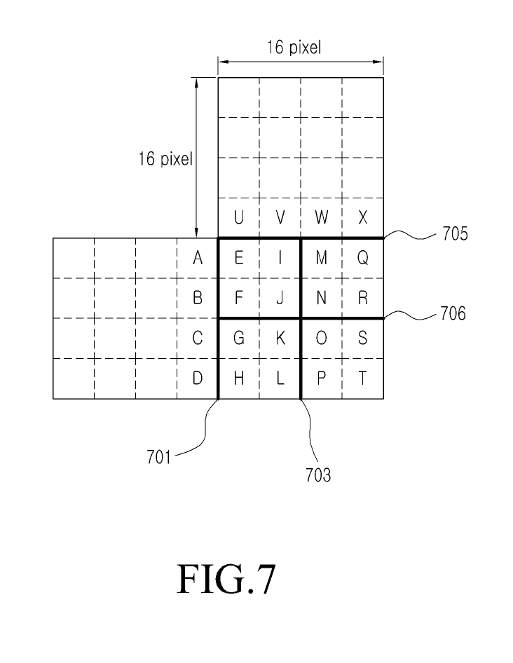

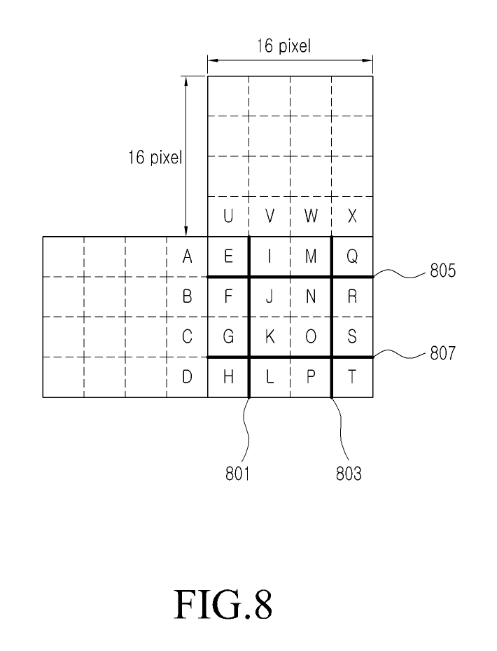

Turning back to FIG. 4, an exemplary embodiment will be described with reference to FIGS. 7 and 8. The BS decider 205 determines BS values for vertical and horizontal even boundaries 701, 703, 705 and 707 in a macro block in the conventional manner in operation 401, and then performs deblocking filtering on the vertical and horizontal even boundaries 701, 703, 705 and 707, whose BS values are determined, in operation 403. In FIG. 7, the vertical even boundaries are located in the 0^{th} and 2^{nd} vertical boundaries 701 and 703 in the macro block, and the horizontal even boundaries are located in the 0^{th} and 2^{nd} horizontal boundaries 705 and 707 in the macro block.

The BS decider 205 determines BS values based on the CBP parameter for vertical and horizontal odd boundaries 801, 803, 805 and 807 in the macro block in operation 405, and then performs deblocking filtering on the vertical and horizontal odd boundaries 801, 803, 805 and 807, whose BS values are determined, in operation 407. In FIG. 8, the vertical odd boundaries are located in the 1^{st} and 3^{rd} vertical boundaries 801 and 803 in the macro block, and the horizontal odd boundaries are located in the 1^{st} and 3^{rd} horizontal boundaries 805 and 807 in the macro block.

In the example of FIG. 4, after BS value determining and filtering are performed on the even boundaries, BS value determining and filtering are performed on the odd boundaries, but the BS value determining and filtering may be performed in reverse order or in parallel. It is also possible to first determine BS values for even and odd boundaries, and then perform filtering.

In accordance with the method of FIG. 4, BS values are determined based on the CBP parameter value, for the odd boundaries in the macro block, thereby reducing the number of Select Cases and thus further reducing computational complexity of the deblocking filtering apparatus.

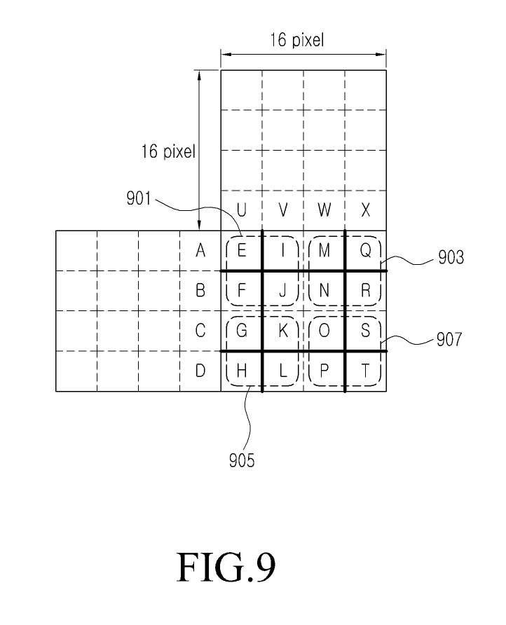

FIG. 9 shows BS value determining and filtering coverage for odd boundaries in a macro block according to an exemplary embodiment. It is assumed in the example of FIG. 9 that four 8×8 unit blocks 901, 903, 905 and 907 are included in a 16×16 macro block.

Referring to FIG. 9, the BS value decider 205 determines four predefined BS values for vertical and horizontal odd boundaries E-I, F-J, E-F and I-J existing in the first unit block 901, and the filter 207 performs deblocking filtering on the odd boundaries E-I, F-J, E-F and I-J according to the determined BS values. The BS values may be set to one of, for example, 1 to 4, according to the filtering strength, and the same BS values may be determined for the four boundaries E-I, F-J, E-F and I-J, or a different BS value may be determined for at least one of the four boundaries considering the pixel blocks E, I, F and J. Similarly, even for vertical and horizontal odd boundaries M-Q, N-R, M-N and Q-R in the second unit block 903, vertical and horizontal odd boundaries G-K, H-L, G-H and K-L in the third unit block 905, and vertical and horizontal odd boundaries Q-S, P-T, O-P and S-T in the fourth unit block 907, the deblocking filter determines BS values and performs deblocking filtering in the same manner as that used for the first unit block 901.

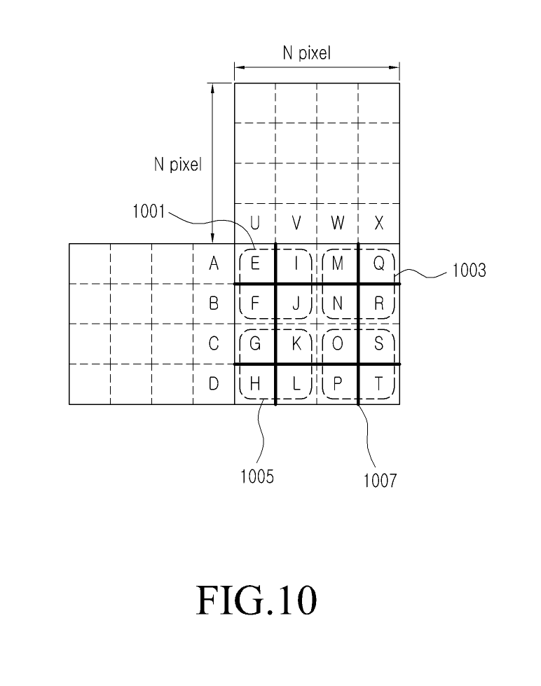

FIG. 10 shows an example in which BS value determining and filtering coverage for odd boundaries described in FIG. 9 are applied to an extended N×N macro block.

Referring to FIG. 10, even if large macro blocks are used, for example, a 32×32 or 64×64 macro blocks, the deblocking filter may determine BS values and perform deblocking filtering for the vertical and horizontal odd boundaries in unit blocks 1001, 1003, 1005 and 1007 having a CBP parameter value in the manner described in FIG. 9.

As is apparent from the foregoing description, according to exemplary embodiments, a low-complexity deblocking filter can be provided, which may be effectively used even in an apparatus using limited hardware resources, like a mobile terminal. Such low-complexity deblocking filter or elements of the low-complexity deblocking filter may be embodied in a processor or may be in software that is executed by a processor.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A deblocking filtering apparatus for removing block distortion of image data, comprising:
a parameter extractor which extracts parameter information for a plurality of unit blocks in a macro block, from a header of an input current frame;
a decision unit which determines whether to perform deblocking filtering, based on the extracted parameter information; and
a filter which is operable to perform deblocking filtering on the macro block according to a determination result of the decision unit.

2. The deblocking filtering apparatus of claim 1, further comprising a skip mode determiner which determines whether a mode type of the macro block is a skip mode, based on the header of the input current frame.

3. The deblocking filtering apparatus of claim 2, wherein if the mode type of the macro block is the skip mode, the decision unit determines not to perform the deblocking filtering on the macro block.

4. The deblocking filtering apparatus of claim 1, wherein upon determining to perform deblocking filtering based on the extracted parameter information, the decision unit determines at least one filter coefficient for the deblocking filtering according to the parameter information for the plurality of unit blocks.

5. The deblocking filtering apparatus of claim 1, wherein the parameter information comprises a Coded Block Pattern (CBP) parameter indicating execution or non-execution of entropy coding.

6. The deblocking filtering apparatus of claim 5, wherein if the CBP parameter has a value of “0”, the decision unit determines not to perform the deblocking filtering on a relevant unit block in the macro block.

7. The deblocking filtering apparatus of claim 4, wherein the decision unit is adapted to determine the at least one filter coefficient separately for even boundaries and odd boundaries between a plurality of pixel blocks of the macro block.

8. The deblocking filtering apparatus of claim 7, wherein one of the plurality of unit blocks includes the plurality of pixel blocks.

9. The deblocking filtering apparatus of claim 8, wherein the decision unit determines the at least one filter coefficient for the odd boundaries according to the extracted parameter information.

10. The deblocking filtering apparatus of claim 4, wherein the at least one filter coefficient is a Boundary Strength (BS) value for adjusting strength of the deblocking filtering.

11. A deblocking filtering method for removing block distortion of image data, comprising:
extracting parameter information for a plurality of unit blocks in a macro block, from a header of an input current frame;
determining whether to perform deblocking filtering, based on the extracted parameter information; and
performing deblocking filtering on the macro block according to the determining.

12. The deblocking filtering method of claim 11, further comprising:
determining whether a mode type of the macro block is a skip mode, based on the header of the input current frame; and
not performing the deblocking filtering on the macro block, if the mode type of the macro block is the skip mode.

13. The deblocking filtering method of claim 11, wherein upon determining to perform the deblocking filtering based on the extracted parameter information, the determining comprises determining at least one filter coefficient for the deblocking filtering according to the parameter information for the plurality of unit blocks.

14. The deblocking filtering method of claim 11, wherein the parameter information comprises a Coded Block Pattern (CBP) parameter indicating execution or non-execution of entropy coding.

15. The deblocking filtering method of claim 14, wherein if the CBP parameter has a value of “0”, the determining comprises not performing the deblocking filtering on a relevant unit block in the macro block.

16. The deblocking filtering method of claim 13, wherein the determining comprises determining the at least one filter coefficient separately for even boundaries and odd boundaries between a plurality of pixel blocks in the macro block, wherein each of the plurality of unit blocks includes the plurality of pixel blocks.

17. The deblocking filtering method of claim 16, wherein the determining comprises determining the at least one filter coefficient for the odd boundaries according to the extracted parameter information.

18. The deblocking filtering method of claim 13, wherein the at least one filter coefficient is a Boundary Strength (BS) value for adjusting strength of the deblocking filtering.

19. A decoding apparatus for decoding image data, the decoding apparatus comprising:
an entropy decoder which restores a residual image of an input frame;
a dequantizer;
an Inverse Discrete Cosine Transform (IDCT) unit;
an inter and intra predictor which generates a predicted picture of an input current frame; and
a deblocking filter which extracts parameter information indicating execution or non-execution of entropy coding, from a header of the input current frame, and optionally performs deblocking filtering on a restored image, restored using the predicted picture of the input current frame, according to the extracted parameter information.

20. The decoding apparatus of claim 19, wherein the deblocking filter comprises:
a parameter extractor which extracts parameter information for a plurality of unit blocks in a macro block, from the header of the input current frame;
a decision unit which determines whether to perform the deblocking filtering, based on the extracted parameter information; and
a filter which is operable to perform deblocking filtering on the macro block according to a determination result of the decision unit.
